(19) United States
(12) Patent Application Publication
(10) Pub. No.: US 2004/0248038 A1
(43) Pub. Date: Dec. 9, 2004

(54) Curable composition excellent in optical characteristics

(76) Inventors: Katsutoshi Yokoyama, Osaka (JP); Kazuya Tsujimura, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/495,074

(22) PCT Filed: Nov. 7, 2002
(86) PCT No.: PCT/JP02/11590

(30) Foreign Application Priority Data
Nov. 7, 2001 (JP) 2001-342039

(51) Int. Cl. G03C 1/73

(52) U.S. Cl. 430/281.1

(57) ABSTRACT

A curable composition comprising:

(a) a first monomer represented by the chemical formula (1):

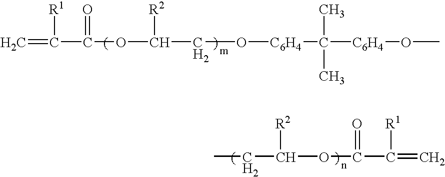

wherein each of R¹ and R² is hydrogen or a methyl group, and the total of m and n is from 0 to 30, and

(b) a second monomer represented by the chemical formula (2):

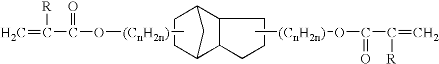

wherein R is hydrogen or a methyl group, and n is from 1 to 10,

has excellent balanced optical properties, and mechanical and thermal properties, and can produce an optical material (plastic lens) having improved colorless transparency and resin brittleness.

### FIELD OF THE INVENTION

The present invention relates to a curable composition which can provide an optical part such as a lens for spectacles and a lens for camera having excellent optical characteristics such as a refractive index, an Abbe number and transparency and having various excellent mechanical properties; and an optics-related product such as an adhesive and a coating agent.

### BACKGROUND ART

Because an organic glass is lighter than an inorganic glass, the organic glass is watched as an optical material, particularly a lens material. Currently, an organic glass comprising a polymer such as diethylene glycol bis(allyl carbonate) is frequently used. The organic glass comprising diethylene glycol bis(allyl carbonate) has a light weight and is excellent in impact resistance, size stability, machinability, dyeability and a hard coating property, and it is frequently used as a lens of eye spectacles instead of the inorganic glass. However, diethylene glycol bis(allyl carbonate) has a high Abbe number of 58 and has low dispersion but a low refractive index of about 1.50, and therefore has defects that the thickness of the lens should be increased in practical use, that the merit of light weight is eliminated, and that bad appearance is imparted.

A derivative of bisphenol A has been recently proposed as a lens material having a larger refractive index for overcoming the above-mentioned defects. Said material has good properties such as impact resistance and curability, but has a relatively high viscosity. Because the workability of said material alone is poor, various lens material compositions comprising said material are developed to make improvements (JP-A-55-13747, and JP-A-59-191708). However, said lens material compositions frequently become opaque or discolor depending on a resin formulation and have an insufficient Abbe number.

### SUMMARY OF THE INVENTION

An object of the present invention is to provide a curable resin composition which can provide an optical material (a plastic lens) having good balanced optical properties (such as a refractive index and an Abbe number), and mechanical and thermal properties (such as thermal resistance and impact resistance) and improved colorless transparency and resin brittleness.

The present invention relates to a curable composition comprising:

(a) a first monomer represented by the chemical formula (1):

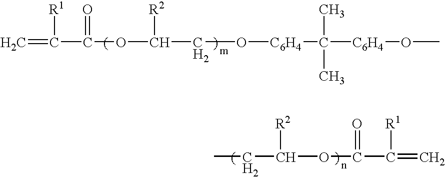

wherein each of R¹ and R² is hydrogen or a methyl group, and the total of m and n is from 0 to 30, and

(b) a second monomer represented by the chemical formula (2):

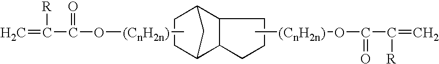

wherein R is hydrogen or a methyl group, and n is from 1 to 10.

### DETAILED DESCRIPTION OF THE INVENTION

The first monomer (a) used in the present invention is a dimethacrylate or diacrylate having an aromatic ring. In the chemical formula (1), each of m and n may be the number of from 1 to 10, particularly from 1 to 5. Specific examples of the first monomer (a) include bisphenol A-ethylene oxide (EO) adduct dimethacrylate, bisphenol A-EO adduct diacrylate, bisphenol A-propylene oxide (PO) adduct dimethacrylate, and bisphenol A-PO adduct diacrylate. These are used alone or in combination thereof.

The second monomer (b) is dimethacrylate or diacrylate having a tricyclodecane group. In the chemical formula (2), n is the number of from 1 to 10, for example, from 1 to 5. Specific examples of the second monomer (b) include dimethylol tricyclodecane dimethacrylate and dimethylol tricyclodecane diacrylate.

The amount of the second monomer (b) is preferably from 10 to 900 parts by weight, more preferably from 20 to 200 parts by weight, based on 100 parts by weight of the first monomer (a).

A third monomer (c) may be used or may not be used. The third monomer (c) can improve physical and mechanical properties, for example, impact resistance, shrinkability and dyeability and can improve or adjust optical properties, for example, refractive index. The third monomer (c) is a polymerizable compound having polymerizability. The third monomer (c) is anyone insofar as a polymer obtained by polymerizing the monomer (c) does not have defective transparency. Specific examples of the third monomer (c) are acrylate or methacrylate esters such as methyl methacrylate, phenyl methacrylate and benzyl methacrylate; aromatic vinyl compounds such as styrene, p-chlorostyrene, bromostyrene, divinylbenzene and vinyl naphthalene; and aromatic di(meth)allyl compounds such as di(meth)allyl orthophthalate, di(meth)allyl isophthalate and di(meth)allyl terephthalate.

The acrylate or methacrylate esters such as methyl methacrylate, phenyl methacrylate and benzyl methacrylate can act as a diluent. The aromatic vinyl compounds such as styrene, p-chlorostyrene, bromostyrene, divinylbenzene and vinyl naphthalene can adjust (for example, increase) the refractive index.

The amount of the third monomer (c) is preferably from 0 to 80 parts by weight, more preferably from 0 to 60 parts by weight, for example, from 1 to 50 parts by weight, based on 100 parts by weight of the first monomer (a).

The curing of the curable composition of the present invention can give an organic glass (particularly, a plastic lens). The organic glass can be obtained by heating and copolymerizing the monomers in the presence of a polymerization initiator by a conventional molding process such as casting process. Alternatively, after the polymerization initiator is added and then the curable composition is previously somewhat polymerized under a given temperature, the curable composition can be charged into a given mold, and heated and cured for the polymerization. The polymerization can be performed also by the use of ionizing radiation such as X-ray and alpha-ray or light such as UV light, visible light and IR light.

A cured material is obtained by polymerizing the monomers. The polymerization is generally a radical polymerization or an ionic polymerization. The polymerization initiator, for example, a radical polymerization initiator or an ionic polymerization initiator can be used to initiate the polymerization.

Examples of the radical polymerization initiator include an organic peroxide and an azo compound. Specific examples thereof include benzoyl peroxide, diisopropyl peroxydicarbonate, t-butyl peroxypivalate, t-butyl peroxyneodecanoate, azoisobutyronitrile and azobisisobutyrovaleronitrile.

The ionic polymerization initiator may be used for the polymerization. Specific examples of a cationic polymerization initiator include a hydroacid such as H₂SO₄ and HClO₄, and a Lewis acid such as BeCl₂ and BF₃. Specific examples of the anionic polymerization initiator include an alkaline metal such as Li and Na, and an alfin catalyst such as C₂H₅Na and C₂H₅Li.

The use amount of the polymerization initiator is preferably at most 10 parts by weight, for example from 0.05 to 5.0 parts by weight, based on 100 parts by weight of the total weight of raw material monomers.

Depending on necessity, the curable composition may contain a colorant such as a dye and a pigment, a UV absorbing agent, an antioxidant, various stabilizing agents, an antistatic agent, a photochromic compound and the like.

The plastic lens can be prepared as follows:

The polymerization initiator and the additives are added to and mixing with the monomers (a) to (c) with stirring, and then degassed. The resultant mixture is cast by a pressure of nitrogen or air into a cast mold assembled from molds and a gasket. The polymerization is performed at 20-120° C. for 1 to 48 hours under the heat. The cured product is demolded to give a lens. In the case of the photopolymerization, a well-known light source such as a chemical lump, a xenon lump and a low or high pressure mercury lump is used to irradiate each mold with an active energy ray, preferably an active energy ray having a wave length of 200 to 600 nm for about 1 minute to about 10 minutes to give a lens. The lens is finished, for example, the outer peripheral is cut and the lens is cleaned, to give a product.

The stirring may be performed by the shaking of a shaking machine or the like. The stirring time varies depending on the raw materials and is generally from 3 minutes to 30 minutes when the viscosity of a system is at most 100 cps.

The degassing expels the air dissolved in the monomers by sometimes shaking the monomers usually under the reduced pressure. If the degassing is insufficient, a large number of fine foams are generated in the molded product and causes a poor product. The degassing time is generally from 3 minutes to 30 minutes for 500 mL cubic when the system has the viscosity of 100 cps.

The cast mold comprises parallel positioned glass molds having different curves which are supported by a ring gasket made of a suitable resin. The gasket has a suitable inject port and the composition can be injected by a injection device having an injection needle. The polymerization can be performed by gradually increasing the temperature from room temperature to at most about 100° C. The temperature increase rate is preferably large as the time passes, in considering a half-life period of the polymerization initiator. In the demolding step, after the completion of the polymerization, the glass molds and the gasket, which are cooled to about 60° C., are deassembled and the cured product is removed. In the case of the photopolymerization, the active energy ray is irradiated and the cured product is removed by deassembling the glass molds and the gasket, and then, if necessary, the cured product can be thermally polymerized for generally 30 minutes to 2 hours. In the finishing step, the outer peripheral of the lens product is cut to adjust the size, and a contaminant on the surface is removed.

### PREFERRED EMBODIMENTS OF THE INVENTION

Hereinafter the present invention is illustrated by Examples which do not limit the present invention.

Properties in Examples and Comparative Examples are evaluated as follows.

Refractive Index and Abbe Number

The refractive index and Abbe number are measured at 25° C. by an Abbe refractometer (manufactured by Atago Co., Ltd.) by using alpha-bromonaphthalene as an intermediate liquid.

Impact Resistance

A lens having a power of −5 diopter and a center thickness of 1.6 mm, which is prepared by a cast polymerization, is subjected to a drop ball test in U.S.A. FDA standards, that is, a test wherein, a steel ball having a diameter of ⅝ inches and a weight of 16.2 g is dropped from a height of 50 inches (about 127 cm) above the lens. The cured material, which is not broken, passes the test (shown by “O”).

Dyeability

A dispersion liquid of SUMIKALON-E-FBL (manufactured by Sumitomo Chemical Co., Ltd.) (1 g) in 1 L of water is heated at 90° C. and a lens is immersed in the dispersion liquid for 10 minutes and then visually observed whether the lens is homogeneously dyed without color unevenness. The lens, which can be homogeneously dyed, passes the test (shown by “O”).

Heat Resistance

According to JIS K 7206 and 7207, a heat distortion temperature (° C.) is measured by a heat distortion tester (manufactured by Toyo Seiki Seisakusho Co., Ltd.).

### EXAMPLE 1

A mixture of:

bisphenol A-ethylene oxide (EO) adduct dimethacrylate [a compound wherein R¹ is a methyl group, R₂ is hydrogen, an average of the total of m and n is 2.6 in the above-mentioned chemical formula (1)] (50 parts by weight), dimethylol tricyclodecane dimethacrylate [a compound wherein n is 1 in the above-mentioned chemical formula (2)] (50 parts by weight), and diisobutylvaleronitrile as a polymerization initiator (0.3 parts by weight) was injected into a mold consisting of two plates of glass and a gasket made of an ethylene/vinyl acetate copolymer (EVA, P-1407 manufactured by Dupont-Mitsui Polychemical Co., Ltd.). The mold was positioned into a constant temperature bath, and the temperature of the bath was gradually increased from 30° C. to 105° C. over 20 hours. The resultant resin was demolded and then heated for post-polymerization at 110° C. for 2 hours. The cured resin was colorless transparent, and had a refractive index of 1.55, an Abbe number of 42 and a heat distortion temperature of 98° C. A lens having a power of −5 diopter and a center thickness of 1.6 mm which was prepared by a cast polymerization was subjected to a impact resistance test and the lens was not broken.

### EXAMPLES 2 TO 5

A mixture having ingredients shown in Table 1 (unit: parts by weight) was cast-polymerized and properties of a cured material were measured as in Example 1. The results are shown in Table 2.

TABLE 1

| | Example 1 | Example 2 | Example 3 | Example 4 | Example 5 |
|---|---|---|---|---|---|
| First | Bisphenol A-EO | Bisphenol A-EO | Bisphenol A-EO | Bisphenol A-EO | Bisphenol A-EO |
| monomer (a) | adduct dimethacrylate | adduct dimethacrylate | adduct dimethacrylate | adduct dimethacrylate | adduct dimethacrylate |
| | (m + n = 2.6) | (m + n = 2.6) | (m + n = 2.6) | (m + n = 2.6) | (m + n = 2.6) |
| | 50 | 50 | 40 | 40 | 45 |
| Second | Dimethylol | Dimethylol | Dimethylol | Dimethylol | Dimethylol |
| monomer (b) | tricyclodecane | tricyclodecane | tricyclodecane | tricyclodecane | tricyclodecane |
| | dimethacrylate | dimethacrylate | dimethacrylate | dimethacrylate | dimethacrylate |
| | 50 | 40 | 50 | 20 | 45 |
| Third | — | Benzyl methacrylate | Styrene | Trimethylol propane | Dimethallyl |
| monomer (c) | | 10 | 10 | trimethacrylate | orthophthalate |
| | | | | 20 | 10 |
| | | | | Hydroxy methacrylate | |
| | | | | 20 | |
| Polymerization | Azobisvaleronitrile | Azobisvaleronitrile | Azobisvaleronitrile | Azobisvaleronitrile | Azobisvaleronitrile |
| initiator | 0.3 | 0.3 | 0.3 | 0.3 | 0.3 |

TABLE 2

| | Example | Example | Example | Example | Example |
|---|---|---|---|---|---|
| | 1 | 2 | 3 | 4 | 5 |
| Refractive | 1.551 | 1.550 | 1.550 | 1.553 | 1.550 |
| index | | | | | |
| (25° C.) | | | | | |
| d-ray | | | | | |
| Abbe | 44 | 42 | 41 | 41 | 43 |
| number | | | | | |
| Impact | ◯ | ◯ | ◯ | ◯ | ◯ |
| resistance | | | | | |
| Dyeability | ◯ | ◯ | ◯ | ◯ | ◯ |
| Heat | 98 | 100 | 105 | 103 | 95 |
| resistance | | | | | |
| (° C.) | | | | | |

### COMPARATIVE EXAMPLE 1

A mixture of dimethylol tricyclodecane dimethacrylate (100 parts by weight) and azoisobutyronitrile as a polymerization initiator (0.1 parts by weight) was cast-polymerized as in Example 1 to give a colorless transparent resin. The resin had a refractive index of 1.529 and an Abbe number of 53, but the impact resistance of the resin was poor.

### COMPARATIVE EXAMPLES 2 TO 4

A mixture having ingredients shown in Table 3 (unit: parts by weight) was cast-polymerized and properties of a cured material were measured as in Example 1. The results are shown in Table 4.

TABLE 3

| | Comparative | Comparative | Comparative | Comparative |
|---|---|---|---|---|
| | Example 1 | Example 2 | Example 3 | Example 4 |
| First | — | Bisphenol | Bisphenol | Bisphenol |
| monomer (a) | | A-EO adduct | A-EO adduct | A-EO adduct |
| | | dimeth- | dimeth- | dimeth- |
| | | acrylate | acrylate | acrylate |
| | | (m + n = | (m + n = | (m + n = |
| | | 2.6) | 2.6) | 2.6) |
| | | 50 | 20 | 100 |
| Second | Dimethylol | — | — | — |
| monomer (b) | tricyclodecane | | | |
| | dimethacrylate | | | |
| | 100 | | | |
| Third | — | Benzyl | Styrene | — |
| monomer (c) | | methacrylate | 80 | |
| | | 50 | | |
| Poly- | Azoiso- | Azobis- | Azobis- | Azobis- |
| merization | butyronitrile | valeronitrile | valeronitrile | valeronitrile |
| initiator | 0.1 | 0.3 | 0.3 | 0.3 |

TABLE 4

| | Comparative | Comparative | Comparative | Comparative |
|---|---|---|---|---|
| | Example 1 | Example 2 | Example 3 | Example 4 |
| Refractive | 1.528 | 1.560 | 1.570 | Because |
| index (25° C.) | | | | monomers |
| d-ray | | | | had high |
| Abbe number | 53 | 35 | 27 | viscosity, |
| Impact | X | ◯ | X | homo- |
| resistance | | | | geneous |
| Dyeability | X | ◯ | X | polymer |
| Heat resistance | 150 | 98 | 100 | cannot be |
| (° C.) | | | | obtained. |

### Effects of the Invention

The curable composition of the present invention can be used for optical parts (particularly, an optical lens) such as a lens for spectacles and a camera lens and additionally for optics-related product such an adhesive and a coating agent. The curable material of the present invention is suitable for an optical material. The plastic lens of the present invention has excellent optical properties such as a refractive index, an Abbe number and transparency and is excellent in various mechanical and physical properties (for example, heat resistance, light weight, impact resistance, size stability, machinability and close adherence of hard coat).

1. A curable composition comprising:
(a) a first monomer represented by the chemical formula (1): 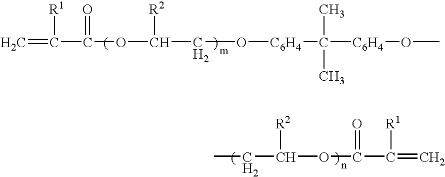
wherein each of R¹ and R² is hydrogen or a methyl group, and the total of m and n is from 0 to 30, and
(b) a second monomer represented by the chemical formula (2): 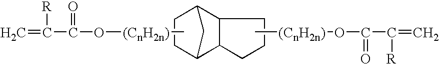
wherein R is hydrogen or a methyl group, and n is from 1 to 10.

2. The curable composition according to claim 1, which also contains a polymerizable third monomer (c) in addition to the first monomer (a) and the second monomer (b).

3. The curable composition according to claim 1, wherein the amount of the second monomer (b) is from 10 to 900 parts by weight, and the amount of the third monomer (c) is from 0 to 80 parts by weight, based on 100 parts by weight of the first monomer (a).

4. The curable composition according to claim 1, wherein the first monomer (a) is bisphenol A-ethylene oxide adduct diacrylate or dimethacrylate, or bisphenol A-propylene oxide adduct diacrylate or dimethacrylate, and
the second monomer (b) is tricyclodecane diacrylate or tricyclodecane dimethacrylate.

5. A plastic lens obtained by curing the curable composition according to claim 1.

6. The curable composition according to claim 2, wherein the amount of the second monomer (b) is from 10 to 900 parts by weight, and the amount of the third monomer (c) is from 0 to 80 parts by weight, based on 100 parts by weight of the first monomer (a).

7. The curable composition according to claim 2, wherein the first monomer (a) is bisphenol A-ethylene oxide adduct diacrylate or dimethacrylate, or bisphenol A-propylene oxide adduct diacrylate or dimethacrylate, and the second monomer (b) is tricyclodecane diacrylate or tricyclodecane dimethacrylate.

8. The curable composition according to claim 3, wherein the first monomer (a) is bisphenol A-ethylene oxide adduct diacrylate or dimethacrylate, or bisphenol A-propylene oxide adduct diacrylate or dimethacrylate, and the second monomer (b) is tricyclodecane diacrylate or tricyclodecane dimethacrylate.

9. The curable composition according to claim 6, wherein the first monomer (a) is bisphenol A-ethylene oxide adduct diacrylate or dimethacrylate, or bisphenol A-propylene oxide adduct diacrylate or dimethacrylate, and the second monomer (b) is tricyclodecane diacrylate or tricyclodecane dimethacrylate.

10. A plastic lens obtained by curing the curable composition according to claim 2.

11. A plastic lens obtained by curing the curable composition according to claim 3.

12. A plastic lens obtained by curing the curable composition according to claim 4.

13. A plastic lens obtained by curing the curable composition according to claim 6.

14. A plastic lens obtained by curing the curable composition according to claim 7.

15. A plastic lens obtained by curing the curable composition according to claim 8.

16. A plastic lens obtained by curing the curable composition according to claim 9.
